(19) United States
(12) Patent Application Publication
(10) Pub. No.: US 2026/0355825 A1
(43) Pub. Date: Nov. 12, 2026

(54) TECHNIQUE FOR CALIBRATION OF AN IRRADIATION SYSTEM OF AN APPARATUS FOR ADDITIVE MANUFACTURING

(71) Applicant: Nikon SLM Solutions AG, Luebeck (DE)

(72) Inventor: Jan Wilkes, Luebeck (DE)

(21) Appl. No.: 19/131,845

(22) PCT Filed: Dec. 20, 2023
(86) PCT No.: PCT/EP2023/086961

§ 371 Date: May 21, 2025

(30) Foreign Application Priority Data
Dec. 30, 2022 (DE) 10 2022 135 050.9

(51) Int. Cl. B22F 10/31; B22F 10/28; B22F 10/85; B33Y 10/00; B33Y 30/00; B33Y 50/02

(52) U.S. Cl. CPC B22F 10/31; B22F 10/28; B22F 10/85; B33Y 10/00; B33Y 30/00; B33Y 50/02

(57) ABSTRACT

A method for calibration of an irradiation system of an apparatus for additive manufacturing is provided. The method comprises applying a powder layer onto a work area of the apparatus, measuring a topography of at least a section of the powder layer, based on the measured topography, determining at least one lateral correction value for an irradiation beam of the irradiation system, and applying the lateral cor-rection value to scanning data used by the irradiation system for scanning the irradiation beam over the work area. Further, an apparatus for additive manufacturing is provided.

The present invention generally relates to calibration of an irradiation system of an apparatus for additive manufacturing. More precisely, and without limitation, the apparatus for additive manufacturing may be an apparatus for powder bed fusion, such as selective laser sintering, selective laser melting, or electron beam melting.

Powder bed fusion is an additive layering process by which pulverulent, in particular metallic and/or ceramic raw materials can be processed to three-dimensional workpieces of complex shapes. To that end, a raw material powder layer is applied onto a carrier and subjected to radiation (e.g., laser or particle radiation) in a site-selective manner in dependence on the desired geometry of the workpiece that is to be produced. The radiation penetrating into the powder layer causes heating and consequently melting or sintering of the raw material powder particles. Further raw material powder layers are then applied successively to the layer on the carrier that has already been subjected to radiation treatment, until the workpiece has the desired shape and size. Powder bed fusion may be employed for the production of prototypes, tools, replacement parts, high value components, or medical prostheses, such as, for example, dental or orthopedic prostheses, on the basis of CAD data. Examples for powder bed fusion techniques include selective laser melting, selective laser sintering, and electron beam melting.

Apparatuses are known for producing one or more workpieces according to the above technique. For example, EP 2 961 549 A1 and EP 2 878 402 A1, respectively, describe an apparatus for producing a three-dimensional workpiece according to the technique of selective laser melting. The general principles described in these documents may also apply to the technique of the present disclosure.

In order to precisely determine a position of the irradiation beam with regard to a work area, to which the irradiation beam is irradiated, several techniques of calibration are known. In particular, in case more than one irradiation beams can be emitted and independently scanned by an irradiation system of an additive manufacturing apparatus, it is important that the irradiation beams are calibrated relative to each other. In other words, it is important for achieving a desired quality of the workpiece (without undesired edges and/or other irregularities in a structure of the finished workpiece) that all irradiation beams impinge exactly on the same spot of the work area, when they are directed to the same spot by a control unit of the apparatus.

For example, WO 2019/161886 A1 describes a method for aligning a multi beam irradiation system for use in an apparatus for producing a three-dimensional work piece by irradiating layers of a raw material powder with electromagnetic or particle radiation. The method of WO 2019/161886 A1 comprises the steps of: i) applying a first raw material powder layer onto a carrier so as to define an irradiation plane to be irradiated with radiation beams emitted by the irradiation system; ii) producing a first test structure in the first raw material powder layer in an overlap zone of the irradiation plane using a first radiation beam emitted by a calibrated first irradiation unit of the irradiation system; iii) producing a second test structure in the first raw material powder layer in the overlap zone of the irradiation plane using a second radiation beam emitted by a calibrated second irradiation unit of the irradiation system; iv) determining an offset between the first and the second test structure in the irradiation plane; and v) aligning at least one of the first and the second calibrated irradiation unit based on the determined offset between the first and the second test structure in such a manner that the offset does not exceed a threshold value.

Further, EP 3 907 021 A1 describes a method of automated alignment of scanning optics for additive manufacturing. The method of EP 3 907 021 A1 includes the following steps: irradiating an object area of a layer of a powdered material provided on a building platform with at least one irradiation beam, irradiating a calibration area of the layer of the powdered material with at least one irradiation beam, guiding the first irradiation beam with the first scanning optic over the intermediate top face and thereby melting a first calibration pattern into the intermediate top face, guiding the second irradiation beam with the second scanning optic over the intermediate top face and thereby melting a second calibration pattern into the intermediate top face, acquiring at least one image of the intermediate top face, using the at least one image, identifying image points related to the geometrical features of the calibration patterns, from the image points, deriving a spatial offset between the second geometrical features, and aligning at least one of scanning optic under consideration of the spatial offset.

Further, methods of calibration are known, which use calibration foils that can be brought into the work area of an apparatus for additive manufacturing and into which predefined patterns are burnt by one or more lasers. A relative position of these one or more patterns can be observed, e.g., by a camera and one or more correction values can be determined for the respective laser(s).

Instead of the calibration foils, it is known to provide sensors (in particular, two dimensional sensors) in the work area or next to the work area, at a bottom region of the build chamber. These sensors may be CCD sensors or CMOS sensors configured to determine an irradiation location of a laser beam with regard to a surface of the sensor. Based on the determined irradiation location, correction values may be determined, such that one or more lasers of the apparatus impinge on a desired location.

However, the above techniques assume an ideal situation during the build job, in particular with regard to properties of the applied raw material layer. However, in real life scenarios, the above calibration techniques may still be not accurate enough.

The invention is therefore directed at the object of providing an improved technique for calibration of an irradiation system of an apparatus for additive manufacturing. In particular, and without limitation, it is desired to provide a technique that leads to an improved accuracy in calibrating one or more irradiation beams of an apparatus for additive manufacturing.

This object is addressed by the subject-matter of the independent claims. Advantageous embodiments are indicated in the dependent claims.

The techniques discussed above do not take into account an actual topography of an applied powder layer (e.g., a curvature or tilt). However, the topography (in particular in case it is not exactly flat or tilted) may have an influence on the locations where one or more irradiation beams impinge on the raw material powder. The technique disclosed in the present disclosure takes into account the topography of the powder layer for calibrating one or more irradiation beams.

According to a first aspect, a method for calibration of an irradiation system of an apparatus for additive manufacturing is provided. The method comprises applying a powder layer onto a work area of the apparatus, measuring a topography of at least a section of the powder layer, based on the measured topography, determining at least one lateral correction value for an irradiation beam of the irradiation system, and applying the lateral correction value to scanning data used by the irradiation system for scanning the irradiation beam over the work area.

One or more of the following features of the method aspect may also apply to the device of the device aspect described below. When, in the present disclosure, the term “workpiece” is used, it always refers to the “three-dimensional workpiece”.

The process of additive manufacturing, via which the workpiece is generated, may be additive manufacturing from a powder bed, such as selective laser sintering or selective laser melting, or any other additive manufacturing process, where a workpiece is build up from raw material powder by irradiating an irradiation beam onto the raw material powder and thereby solidifying the raw material powder at desired locations.

The powder layer may be applied by a powder application device (also referred to as powder coating device). The powder application device may comprise a powder hopper, in which a certain amount of powder can be stored, e.g., at least as much powder necessary for applying one full powder layer. Further, the powder application device may comprise one or more rollers and one or more blades. The one or more rollers may be configured to compress the raw material powder and/or to generate a uniform surface. The one or more blades may be configured to generate a smooth and uniform surface having a uniform thickness. The one or more blades may further be configured to remove excess raw material powder from the work area. For example, the one or more blades may be configured to push excess raw material powder into an overflow container for excess powder. The powder application device may have an elongated shape extending along a first direction (e.g., y-direction) and may be configured to move along a second direction perpendicular to the first direction (e.g., x-direction), e.g., guided via one or more rails.

In order to control a thickness of the applied powder layer, the powder application device or at least parts of the powder application device (e.g., a blade) may be vertically movable (i.e., along a z-direction). Further, the thickness of the powder layer may be controlled by setting a vertical position of a carrier of the apparatus, on which the raw material powder is applied in layers.

The work area may be defined as an area in which application of the raw material powder and irradiation of the raw material powder is carried out. The work area may be flush with a bottom of a process chamber of the apparatus. In other words, the work area defines a (virtual) area or plane, parallel to a surface of a carrier and/or substrate plate of the apparatus. In an ideal case, every new raw material powder layer is applied such that it extends exactly in or above the work area (without any curvature and/or bumps or dents).

However, in real life situations, the applied powder layer may have a topography different from a flat plane. This topography is measured, at least in a section of the powder layer. The expression “topography” may be synonymous and therefore may be replaced with “three-dimensional structure” or “height profile”. In particular, the measurement of the topography may result in a height profile of the measured section, wherein a curvature, a bump, and/or a dent can be identified with regard to both a location in the x-y-plane (i.e., in the work area) and with regard to a depth/height along the z-direction.

In the step of measuring, either the entire powder layer may be measured or only a predefined section thereof. For example, the topography may only be measured in a section of the powder layer, where two or more irradiation areas of corresponding two or more irradiation beams overlap (i.e., in an overlap region of two or more irradiation beams).

The lateral correction value may be determined such that a position of the irradiation beam is corrected and such that the irradiation beam impinges onto the raw material layer at a lateral position (in the x-y-plane) where it would impinge if the powder layer was completely flat and parallel to the x-y-plane.

The lateral correction value may be applied at different (logical) positions with regard to the scanning data. For example, the “original” scanning data may remain unchanged and the correction value may be added to the scanning data before it is fed to the irradiation system. Further, the scanning data may be modified by adding the correction value and the modified scanning data may be fed to the irradiation system.

The at least one lateral correction value may be one correction value for the entire powder layer. However, it may be desirable to provide a plurality of correction values, in particular one correction value for each lateral position (x-y-position) of the powder layer. In this way, local irregularities in the powder layer may be compensated. For example, in case there is a bump in a particular region of the powder layer, correction values (different from zero) may only be provided for this particular region.

The lateral correction value may indicate an offset in the x-y-plane (e.g., indicated in mm or μm) or it may indicate an angular offset with regard to an irradiation angle of the irradiation beam (e.g., indicated in degrees).

The method may further comprise irradiating the powder layer with the irradiation beam according to the scanning data to which the lateral correction value has been applied.

In the step of irradiating the powder layer, the irradiation beam may generate a melt pool at desired locations of the powder layer, such that the powder melts at the desired locations and solidifies to form a predefines geometry of a workpiece layer of the workpiece to be produced.

The method may further comprise calibrating a lateral position of the irradiation beam with regard to a horizontal plane in the work area.

In this step of calibrating, the irradiation beam is calibrated with regard to an ideal flat plane extending in the work area. For example, a method of calibration as described in WO 2019/161886 A1 or EP 2 961 549 A1 may be used. This calibration may already provide a quite good calibration for the position of one or more irradiation beams emitted by the irradiation system. The step of calibrating may be carried out, e.g., before the powder layer is applied to the work area and, in particular, before a first powder layer is applied to the work area. However, the step of calibrating may also be carried out after the powder layer is applied, e.g., by irradiating a section of the work area that is not used for the workpiece. Further, during the step of calibration, one or more detectable areas, sensors or calibration foils may be irradiated, which are not provided within the work area but next to it, e.g., in a bottom region of the process chamber.

Thus, it can be assumed for the method described herein, that a (first order) calibration has already been carried out with regard to a horizontal plane in the work area. The irradiation beams are therefore already calibrated to a certain degree and the method of the present disclosure provides a refinement of this (first order) calibration. Further, the step of calibrating may be carried out for every N layers (N may be 1, 2, 3, 4, or 5, for example) and the method of the first aspect may be carried out for every layer of raw material powder applied onto the work area. Thus, for example, drift caused, e.g., by thermal effects may be compensated by the calibration with regard to the horizontal plane and irregularities in the powder layer may be compensated by the method of the first aspect.

The topography may be measured via a stripe light projection method.

A stripe light pattern may be projected onto the powder layer and may be observed by one or more cameras, in particular from different angles. This technique may also be referred to as 3D scanning. In particular, a projector may project a stipe light pattern onto the powder layer and two cameras may observe the resulting pattern from different angles. Based on the generated camera images, the topography of the workpiece layer can be calculated. This technique is known to the person skilled in the art. The device used for measuring the topography may also be referred to as structured-light 3D scanner.

Further methods for measuring the topography of the powder layer, which may be applied in the method of the present disclosure, may comprise at least one of line scanning, optical coherence tomography, and laser triangulation. These methods are known to the person skilled in the art.

The method may further comprise determining a predefined lateral position where the irradiation beam shall impinge onto the powder layer. The lateral correction value may be determined such that the irradiation beam impinges onto the powder layer at the predefined lateral position.

The predefined lateral position may be indicated via x-and y-coordinates in the work area. Due to a topography of the powder layer, the irradiation beam may not impinge at the predefined lateral position, when it is direct there, even when a calibration with regard to an ideal horizontal plane has been carried out. For example, in case a thickness of the raw material powder layer is larger than expected (due to the calibration with regard to the horizontal plane), a deflection angle (i.e., deflection from perpendicular radiation) of the laser beam may have to be increased in order to impinge on the desired x-y-location. In case a thickness of the raw material powder layer is smaller than expected (due to the calibration with regard to the horizontal plane), a deflection angle (i.e., deflection from perpendicular radiation) of the laser beam may have to be decreased in order to impinge on the desired x-y-location. These calculations may be carried out by a control unit of the apparatus for additive manufacturing. They involve standard geometric calculations, which are known to the skilled person and which are therefore not described in detail herein.

The lateral correction value may be determined such that the irradiation beam impinges onto the powder layer at a lateral position corresponding to a lateral position of an intersection point of the irradiation beam without the lateral correction value and a horizontal plane in the work area.

Hence, an imaginary intersection point (in x-y-direction) of the horizontal plane with the irradiation beam may be considered. This intersection point may correspond to x-y-irradiation data indicated in irradiation data for the respective workpiece. The lateral correction value may be calculated such that the actual irradiation beam (i.e., the irradiation beam, to which the correction value is applied), impinges on the (real) powder layer at exactly this (desired) lateral position.

The method may further comprise, based on the measured topography, determining at least one further lateral correction value for a further irradiation beam of the irradiation system, and applying the further lateral correction value to further scanning data used by the irradiation system for scanning the further irradiation beam over the work area.

All of the details and aspects described above with regard to determining the lateral correction value for the irradiation beam may apply accordingly for determining the further lateral correction value for the further irradiation beam.

The lateral correction value and the further lateral correction value may be determined such that the irradiation beam and the further irradiation beam irradiate the same spot on the powder layer when the irradiation beam without the lateral correction value and the further irradiation beam without the further lateral correction value would irradiate the same spot on a horizontal plane in the work area.

The method may further comprise irradiating a first structure into the powder layer using the irradiation beam, irradiating a second structure into the powder layer using the further irradiation beam, determining a lateral position of the first structure and a lateral position of the second structure, and, based on the measured topography, the lateral position of the first structure, and the lateral position of the second structure, determining at least one of the at least one lateral correction value and the at least one further correction value.

In this way, both a calibration with regard to the work area and a calibration with regard to the topography of the powder layer may be carried out, e.g., substantially at the same time. The first and second structure does not necessarily consist of or result from a melt pool at the irradiated sections. It may be sufficient that the structures are visible, either during irradiation or shortly afterwards, e.g., with a camera.

In this regard, the term structure may also refer to irradiation, which may be detected during or within a period after exposure by the irradiation beam, but which does not result in permanent changes of the exposed material. In other words, the structure may be a purely “optical” structure visible due to scattered light during irradiation but being invisible after irradiation. In case it is sufficient that the two irradiation beams are calibrated with regard to each other (i.e., only relatively and not absolutely), it may be sufficient to determine only one of the lateral correction value and the further lateral correction value. However, in case an absolute calibration (i.e., with regard to coordinate system of the apparatus, in other words, with regard to the work area) is desired, both the lateral correction value and the further lateral correction value may be determined.

The method may be carried out for a plurality of consecutive powder layers.

In particular, the method may be carried out for each powder layer applied and irradiated for the workpiece to be generated (i.e., each powder layer of the build job). However, the method may also be carried out for every M layer, wherein M may be 2, 3, 4, 5, 6, 7, 8, 9 or 10, for example.

The at least one lateral correction value may be determined based on the measured topography of the applied powder layer and based on a measured topography of a previously applied powder layer.

Thus, not only the topography of the current layer, but also a topography of an underlying layer may be considered, since the topography of the underlying layer may have influence on a height of the solidified structures of the current layer.

The method may further comprise, based on the measured topography, determining at least one vertical correction value for the irradiation beam of the irradiation system, and applying the vertical correction value to a focusing optic of the irradiation system.

In other words, not only a lateral position may be corrected, but also a focus position of the irradiation beam. For example, a focus length may be reduced in case the topological profile is higher and/or an actual powder layer is thicker as expected, e.g., only at lateral positions where this is the case (bumps). Similarly, a focus length may be increased at lateral positions, where the topography comprises dents.

According to a second aspect, an apparatus for additive manufacturing is provided. The apparatus comprises an irradiation system configured to irradiate at least one irradiation beam onto a work area of the apparatus, a powder application device configured to a powder layer onto the work area of the apparatus, a topography measurement device configured to measure a topography of at least a section of the powder layer, and a control unit. The control unit is configured to, based on the measured topography, determine at least one lateral correction value for the irradiation beam of the irradiation system, and apply the lateral correction value to scanning data used by the irradiation system for scanning the irradiation beam over the work area.

All of the above aspects and details discussed with regard to the method aspect (first aspect) may apply to the apparatus aspect. In particular, the apparatus of the second aspect may be configured to carry out the method of the first aspect, wherein one or more of the details discussed above with regard to the method aspect are implemented.

The control unit may be configured to calibrate a lateral position of the irradiation beam with regard to a horizontal plane in the work area.

The topography measurement device may be configured to measure the topography via a stripe light projection method.

The control unit may be configured to determine a predefined lateral position where the irradiation beam shall impinge onto the powder layer. The control unit may be configured to determine the lateral correction value such that the irradiation beam impinges onto the powder layer at the predefined lateral position.

The control unit may be configured to determine the lateral correction value such that the irradiation beam impinges onto the powder layer at a lateral position corresponding to a lateral position of an intersection point of the irradiation beam without the lateral correction value and a horizontal plane in the work area.

The control unit may be further configured to, based on the measured topography, determine at least one further lateral correction value for a further irradiation beam of the irradiation system, and apply the further lateral correction value to further scanning data used by the irradiation system for scanning the further irradiation beam over the work area.

The control unit may be configured to determine the lateral correction value and the further lateral correction value such that the irradiation beam and the further irradiation beam irradiate the same spot on the powder layer when the irradiation beam without the lateral correction value and the further irradiation beam without the further lateral correction value would irradiate the same spot on a horizontal plane in the work area.

The control unit may be further configured to control the irradiation system to irradiate a first structure into the powder layer using the irradiation beam, control the irradiation system to irradiate a second structure into the powder layer using the further irradiation beam, determine a lateral position of the first structure and a lateral position of the second structure, and, based on the measured topography, the lateral position of the first structure, and the lateral position of the second structure, determine at least one of the at least one lateral correction value and the at least one further correction value.

The control unit may be configured to determine the at least one lateral correction value based on the measured topography of the applied powder layer and based on a measured topography of a previously applied powder layer.

The control unit may be configured to, based on the measured topography, determine at least one vertical correction value for the irradiation beam of the irradiation system, and apply the vertical correction value to a focusing optic of the irradiation system.

Preferred embodiments of the invention are described in greater detail with reference to the appended schematic drawings, wherein

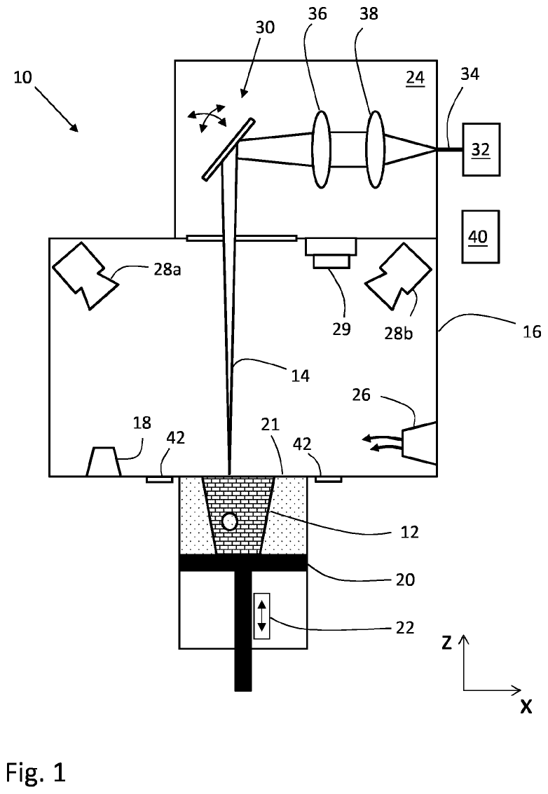

FIG. 1 shows a schematic side view of an apparatus for additive manufacturing with an irradiation system configured to emit one laser beam, according to an embodiment of the present disclosure;

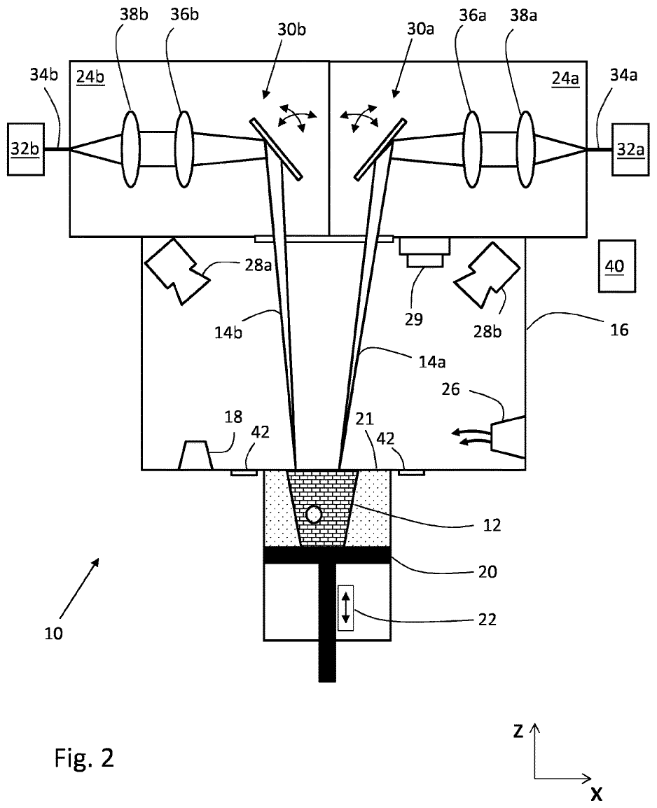

FIG. 2 shows a schematic side view of an apparatus for additive manufacturing with an irradiation system configured to emit two laser beams, according to an embodiment of the present disclosure;

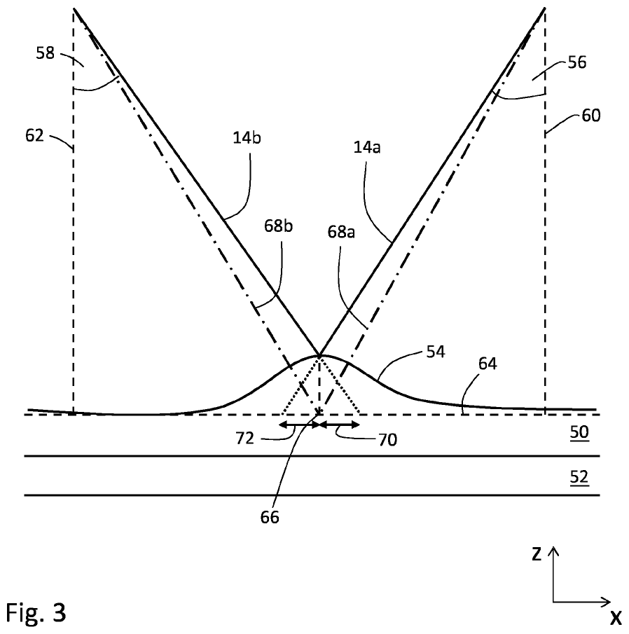

FIG. 3 shows a schematic representation of a powder layer topography, based on which an embodiment of the method for calibration according to the present disclosure is explained;

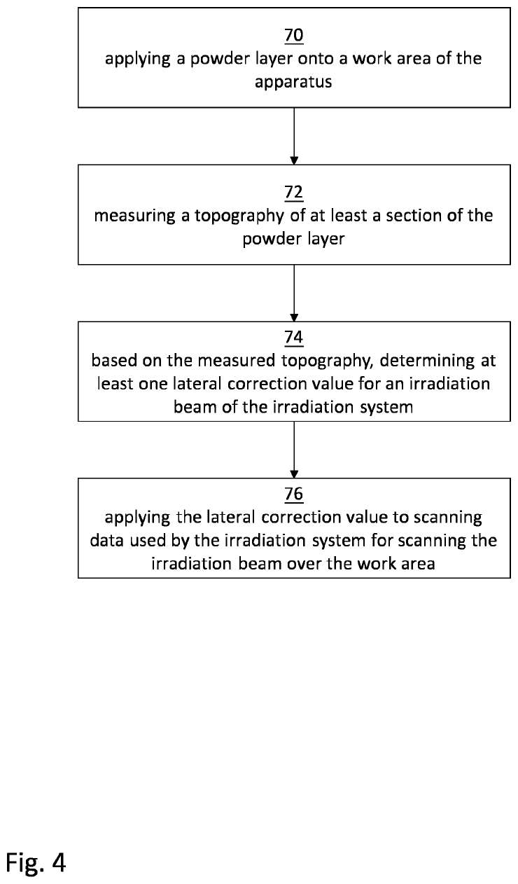

FIG. 4 shows a flowchart of a method according to an embodiment of the present disclosure; and

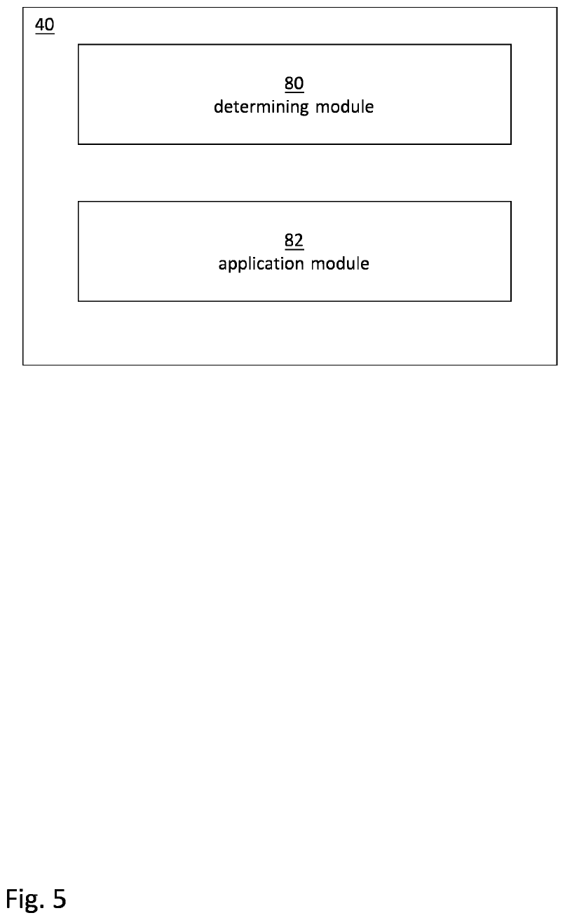

FIG. 5 shows a control unit of the apparatus with modules according to an embodiment of the present disclosure.

FIG. 1 shows a schematic representation of an apparatus 10 for additive manufacturing. The apparatus 10 may also be referred to as apparatus 10 for producing a three-dimensional workpiece 12. The apparatus 10 may, e.g., be based on a typical additive manufacturing apparatus, wherein the method for calibrating the irradiation system, according to the present disclosure, is programmed into a control unit 40 of the apparatus 10. Further, additional components such as a three-dimensional scanning device 28a, 28b, 29 and, optionally, calibration sensors 42 may be provided.

The principles of the apparatus 10 are well known to the person skilled in the art in the field of additive manufacturing and will only be described briefly. For example, such an apparatus 10 may be an apparatus for selective laser melting or an apparatus for selective laser sintering, wherein one or more laser beams 14 may be used for selectively irradiating and solidifying subsequent layers of raw material powder.

The apparatus 10 for carrying out a process of selective laser melting as described below may serve as an example. Typical features of powder bed fusion are that a raw material powder is applied in layers and each layer is selectively irradiated and solidified in order to generate one layer of a workpiece 12 to be produced. After removing excess powder, and after optional steps of post processing (e.g., removing one or more support structures), the final workpiece 12 is obtained.

FIG. 1 shows an apparatus 10 for producing a three-dimensional workpiece 12 by selective laser melting. The apparatus 10 comprises a process chamber 16. The process chamber 16 is sealable against the ambient atmosphere, i.e. against the environment surrounding the process chamber 16.

A powder application device 18, which is arranged in the process chamber 16, serves to apply a raw material powder onto a carrier 20. To this end, the powder application device 18 may comprise at least one of a roller, a blade, and a raw material hopper. The powder application device 18 is configured to apply a substantially uniform layer of raw material powder on top of a previously applied and irradiated layer of raw material powder. In this context, uniform particularly means that the layer shall have a uniform thickness. However, as discussed below, this cannot be guaranteed in real life situations, in particular with regard to small local variations in the thickness of the layer. The layer thickness can be chosen, e.g., by vertically positioning the powder application device 18 and/or the carrier 20.

A work area 21 is defined by a size of the footprint of the carrier 20. The work area 21 is flush with the bottom region of the process chamber 16 and is defined as the area where powder application with the powder application device 18 is carried out and where an uppermost raw material layer is irradiated with one or more laser beams 14.

The powder application device 18 extends in y-direction at least over the entire work area 21, such that is can coat layers of raw material powder “in one run”. For this purpose, a horizontal movement device is provided, which is configured to move the powder application device 18 in a horizontal direction, i.e., in x-direction according to FIG. 1.

A vertical movement unit 22 is provided, such that the carrier 20 can be displaced in a vertical direction so that, with increasing construction height of the workpiece 12, as it is built up in layers from the raw material powder on the carrier 20, the carrier 20 can be moved downwards in the vertical direction.

Since the movability of the carrier 20 by means of the vertical movement unit 22 is well-known in the field of selective laser melting, it will not be explained in detail herein. As an alternative to the movable carrier 20, the carrier 20 may be provided as stationary (or fixed) carrier (in particular, with regard to the vertical z-direction), wherein the irradiation device 24 (see below) and the process chamber 16 are configured to be moved upwards during the build process (i.e., with increasing construction height of the workpiece 12). Further, both the carrier 20 and the irradiation device 24 may be individually movable along the z-direction.

A carrier surface of the carrier 20 defines a horizontal plane (an x-y-plane), wherein a direction perpendicular to said plane is defined as a vertical direction or build direction (z-direction). Hence, each uppermost layer of raw material powder and each layer of the workpiece 12 extend in a plane parallel to the horizontal plane (x-y-plane) defined above. As defined above, also the work area 21 extends in a plane parallel to the horizontal plane (x-y-plane).

The apparatus 10 further comprises a gas inlet 26 for supplying an inert gas (e.g., argon) into the process chamber 16. A gas outlet (not shown) may be provided, such that a continuous stream of gas may be generated through the process chamber 16 by implementing a gas circuit. In a preferred embodiment, a unidirectional laminar flow is generated over the uppermost raw material powder layer along the x-direction.

The apparatus 10 further comprises an irradiation device 24 (also referred to as irradiation unit or optical unit) for selectively irradiating the laser beam 14 onto the uppermost layer of raw material powder applied onto the carrier 20. By means of the irradiation device 24, the raw material powder applied onto the carrier 20 may be subjected to laser radiation in a site-selective manner in dependence on the desired geometry of the workpiece 12 that is to be produced.

In the present embodiment, an irradiation system may be defined as consisting of the one irradiation device 24 configured to emit one laser beam 14. However, as shown, e.g., in FIG. 2, an irradiation system of the apparatus 10 may comprise two or more irradiation devices 24 (more precisely, 24a, 24b), wherein each irradiation device is configured to emit one laser beam 14. The present technique is therefore not limited to an apparatus having only one irradiation device 24 but a plurality of irradiation devices (e.g., 2, 4, 5, 6, 8, 10, 12, 14, etc.) may be provided.

The irradiation device 24 of the apparatus 10 of FIG. 1 comprises a scanning unit 30 configured to selectively irradiate the laser beam 14 onto the raw material powder applied onto the carrier 20. The scanning unit 30 is controlled by a control unit 40 of the apparatus 10. The scanning unit 30 may comprise one mirror tiltable with regard to two perpendicular axes. Alternatively, the scanning unit 30 may comprise two tiltable mirrors, each configured to be tilted with regard to a corresponding axis. The tiltable mirrors may be, e.g., galvanometer mirrors.

The irradiation device 24 is supplied with laser radiation from a laser beam source 32. The laser beam source 32 may be provided within the irradiation device 24 or outside the irradiation device 24, as shown in FIG. 1. In the first case, the laser beam source 32 may be regarded as being part of the irradiation device 24. In the latter case, the laser beam is generated by the laser beam source 32 and guided into the irradiation device 24 via an optical fiber 34. Alternatively, the laser beam may be guided into the irradiation device 24 through the air or through a vacuum, e.g., by using one or more mirrors.

From the laser beam source 32, the laser beam is directed to the scanning unit 30. The laser beam source 32 may, for example, comprise a diode pumped Ytterbium fiber laser emitting laser light at a wavelength of approximately 1070 to 1080 nm (i.e., in the infrared wavelength range).

The irradiation device 24 further comprises two lenses 36 and 38, which are configured to focus the laser beam 14 onto a desired focus position along the z-axis. In the embodiment shown in FIG. 1, both lenses 36 and 38 have positive refractive power. The lens 38 further upstream of the beam path is configured to collimate the laser light emitted by the fiber 34, such that a collimated or substantially collimated laser beam is generated. The lens 36 further downstream of the beam path is configured to focus the collimated (or substantially collimated) laser beam onto a desired z-position.

The control unit 40 comprises a processor and a memory, wherein, on the memory, instructions are stored for controlling the individual components of the apparatus 10. For example, the control unit 40 may be configured to control one or more of the vertical movement unit 22, the powder application device 18, a gas flow supplied by the gas inlet 26, and the irradiation device 24 of the irradiation system. A user input and output interface may be provided and connected or connectable to the control device 40. Further, the control unit 40 has an interface to receive workpiece data representative of a three-dimensional shape of the workpiece 12 to be produced.

The position of the control unit 40 indicated in the figures (FIG. 1 and FIG. 2) is purely schematic and not limiting. The control unit 40 may be provided at any suitable position of the apparatus 10 and it may be also provided remote from the apparatus 10 (e.g., connected to the apparatus 10 via a network such as a LAN). The control unit 40 or at least a part of the control unit 40 may be provided in the form of a cloud computing device.

In addition to the above-described rather common elements of an apparatus for additive manufacturing, the apparatus 10 of the present embodiment comprises the following elements.

A three-dimensional scanning device 28a, 28b, 29 is provided, comprising a projector 29 and two cameras 28a and 28b. In alternative embodiments, the number of projectors and/or cameras may vary, e.g., more than one projector and more than two cameras may be provided. Further, at least one of the camera 28a, the camera 28b, and the projector may be movable. Still further, any other suitable device for determining a topography of a powder layer may be used.

The three-dimensional scanning device operates as a structured-light 3D scanner, the operation of which is generally known by the person skilled in the art and, therefore will not be described in detail herein. The projector 29 is configured to project a stripe pattern onto the powder layer in the work area 21 and the cameras 28a and 28b obtain an image of said stripe pattern from two different angles. It should be noted that the two different angles are not only different with regard to each other but also different from an optical axis of the projector 29. Based on the two images, a topography (also referred to as height profile) may be calculated, for example by a control unit of the three-dimensional scanning device (not shown) or by the control unit 40 of the apparatus 10. The measured topography may be stored in a memory of the control unit 40. For example, the topography may assign one height value (height along the z-direction) to each x-y-value of the work area 21, wherein the number of x-y-values may be determined by a resolution of the three-dimensional scanning device.

Further, the apparatus 10 comprises calibration sensors 42 provided in a bottom region of the process chamber 16, next to the uppermost layer of raw material powder, i.e., next to the work area 21. Alternatively, only one calibration sensor 42 or more than two calibration sensors 42 may be provided. The calibration sensors 42 may be used for carrying out a (absolute) calibration of the laser beam 14 with regard to a coordinate system of the apparatus 10. To this end, the laser beam 14 is directed to at least one of the calibration sensors 42, where it irradiates a predefined pattern. A location of the predefined pattern is detected by the respective calibration sensor 42 and the control unit 40 calculates a suitable correction value for the laser beam 14. Hence, it can be ensured that the laser beam is directed to an exact desired location with regard to the coordinate system of the apparatus 10.

The calibration sensors 42 are optional. They may be replaced, e.g., by at least one detectable area. These are predefined areas, that can be reached and irradiated by the laser beam 14. According to some embodiments, the laser beam does not leave any permanent marks in the detectable area but a structure irradiated onto the detectable area is observed via a camera (e.g., camera 28a or 28b) during the irradiation. In other words, scattered light and/or thermal radiation is detected by the camera. Based on a position of the detected structure, a calibration may be carried out.

In other embodiments, a respective calibration (i.e., calibration with regard to a horizontal plane in the work area 21) may be carried out by irradiating one or more patterns directly into the raw material of an applied raw material layer. During this irradiation, the pattern may melt the powder or may not melt the powder (in particular, may not cause any permanent changes in the irradiated material). A camera observing the work area (e.g., one of the cameras 28a and 28b) takes an image of the pattern or observes the pattern during irradiation (see above) and the control unit 40 determines a suitable correction value for the laser beam 14, such that it can be directed to a desired location with regard to the coordinate system of the apparatus 10.

FIG. 2 shows a different embodiment of an apparatus 10, similar to the apparatus 10 of the embodiment of FIG. 1. As only difference between the two apparatuses 10, the irradiation system of the apparatus 10 of FIG. 2 comprises two irradiation devices 24a and 24b instead of the one irradiation device 24 of the apparatus 10 of FIG. 1. However, the rest of the apparatus 10 of FIG. 2 has the same components and functions as those discussed above with regard to FIG. 1, such that a repetition of this description is omitted. Further, the components of the irradiation devices 24a and 24b have the same reference signs as those of FIG. 2. However, suffixes “a” and “b” are used in order to distinguish between components of the irradiation device 24a (suffix a) and the components of the further irradiation device 24b (suffix b). The function of the individual components within the irradiation devices 24a and 24b is the same as discussed above with regard to the irradiation device 24.

In the following, the use of a reference sign without suffix (a or b) also refers to the respective elements with the suffixes a and b, if not explicitly indicated otherwise. For example, when it is referred to the “scanning unit 30”, it is thereby also referred to the scanning units 30a and 30b.

The apparatus 10 of FIG. 2 is configured such that the irradiation device 24a is configured to scan a first predefined region (i.e., a first scan field) of the uppermost powder layer. Similarly, the further irradiation device 24b is configured to scan a second predefined region (i.e., a second scan field) of the uppermost powder layer. The first scan field and the second scan field overlap each other in an overlap area. In other words, there is a region of the uppermost powder layer that can be reached and selectively irradiated by both laser beams 14a and 14b (i.e., the overlap area). The first scan field and the second scan field may be each rectangular or circular and a size and/or shape of the respective scan field may be predefined by a range of movement of the respective scanning unit 30a and 30b of the irradiation devices 24a and 24b, respectively. The overlap area may also cover the entire work area 21, such that every position of the work area 21 can be reached by both laser beams 14a, 14b.

For producing the three-dimensional workpiece 12, both laser beams 14a and 14b can simultaneously irradiate different sections of the same powder layer, wherein each laser beam 14a and 14b irradiates a section of the workpiece 12 in its corresponding scan field. In this way, the workpiece 12 can be built up faster than in a case where only one laser beam 14 is used (see, e.g., FIG. 1). Further, the two laser beams 14a and 14b may have different parameters, such as laser power, beam profile , spot diameter, and/or wavelength. For example, the control unit 40 may instruct the first laser beam 14a to irradiate a core portion of a workpiece layer and may instruct the second laser 14b to irradiate a shell portion of the workpiece layer (e.g., with a smaller spot diameter and/or with less laser power).

For achieving a high quality of the generated workpiece 12, it is important that the two lasers 14a and 14b are calibrated with regard to each other. In other words, it is important that a relative position of the first laser beam 14a with regard to the second laser beam 14b is known. For example, when both laser beams 14a and 14b shall irradiate the same spot (or one laser beam shall continue to irradiate a line started by the other laser beam), a proper relative calibration is required.

Further, also for the case of only one irradiation device 24 (see FIG. 1) and for the case of more than one irradiation devices 24a, 24b (see FIG. 2), it may be important to provide an absolute calibration, i.e., a calibration with regard to positions of the uppermost powder layer. For example, it may be important, e.g., for a case of hybrid manufacturing, where an object to be repaired is embedded in the powder bed below the uppermost powder layer, to hit a specific predefined position within the uppermost powder layer in order to continue a build of the object to be repaired.

Both an absolute and relative calibration may be achieved, at least in first order, by using the calibration sensors 42 as discussed with regard to FIG. 1 above. For example, both laser beams may radiate a predefined pattern either into the same or into different calibration sensors 42 and based on a lateral offset of the two patterns (and, optionally, based on a known position of the calibration sensors 42 with regard to each other), a correction value may be determined for both lasers (in the case of absolute calibration). In case only relative calibration shall be achieved, it may be sufficient to determine a correction value only for one of the lasers 14a, 14b.

Further, as discussed above, a pattern may be irradiated into the raw material powder layer and observed by a camera. In this regard, see also the calibration process described in WO 2019/161886A1.

However, the one laser beam 14 of FIG. 1 and the two laser beams of FIG. 2 are merely calibrated with regard to a (ideal) horizontal plane in the work area 21 with this calibration method. Irregularities of the topography are taken into account by the technique discussed in the following.

FIG. 3 shows a schematic side view of the situation of FIG. 2, wherein two laser beams 14a and 14b are irradiated onto a powder layer 50 having a topography different from a flat plane. It should be noted that the representation of FIG. 2 is for illustrative purposes only and it is not to scale (meaning that relative sizes and distances may not be correct).

The powder layer 50 has been applied by the powder application device 18 (see FIG. 1 or FIG. 2) on top of an underlying powder layer 52 which already was partly solidified in a preceding irradiation process. The solidified sections are not shown in FIG. 3. In addition to the underlying powder layer 52, further powder layers may exist below powder layer 52. However, the powder layer 50 may also have been applied directly onto the carrier 20.

As shown in FIG. 3, the topography of the powder layer 50 is not ideally flat but comprises a bump (or hill) 54. Such irregularities in the topography of a workpiece layer may have different causes, wherein only a few are mentioned: A solidified part in an underlying layer 52 (or layer below layer 52) may “come up” and thereby cause a bump. A guiding rail over which the powder application device 18 is moved may be curved, tilted, or may have other structural defects. There may be clumps in the powder. There may be a congestion in the powder application device 18. The powder application device 18 (in particular, a blade of the powder application device 18) may be bent or tilted.

Thus, one possible explanation for the bump shown in FIG. 3 is that both guiding rails of the powder application device 18 are bent upwards in the middle, causing the powder application device 18 to apply more powder (i.e., a higher thickness) in the middle of the work area than at edges of the work area 21. The situation shown in FIG. 3 is only exemplary and the technique disclosed herein also applies to other irregularities (e.g., irregularities along the y-direction, dents, etc.)

Further, an irradiation angle 56 of the laser beam 14a and an irradiation angle 58 of the laser beam 14b are indicated in FIG. 3. The irradiation angle is determined with regard to a surface normal of the x-y-plane (indicated as dashed line 60 and 62, respectively, in FIG. 3), i.e., with regard to the z-axis.

The irradiation devices 24a and 24b (see FIG. 1 or FIG. 2) are pre-calibrated such that when each of the irradiation devices 24a and 24b directs a laser beam to a same position within the x-y-plane of an ideally flat powder layer, they would hit this position. This situation is shown in FIG. 3, wherein the (hypothetical) ideally flat powder layer is indicated by a dashed line 64 and the (hypothetical) laser beams directed to the same x-y-position 66 are indicated with dash-dotted lines as 68a and 68b, respectively. The dashed line 64 and the dash-dotted lines 68a and 68b show a hypothetical situation, i.e., a situation in which the bump 54 does not exist. However, in the example of FIG. 3, the bump 54 exists and an irradiation angle of each of the laser beams has to be corrected in order to irradiate the same desired position 66. More precisely, an irradiation angle of each of the laser beams has to be corrected such that they are not irradiated as shown by reference numerals 68a, 68b but as shown by reference numerals 14a, 14b.

In order to impinge on the same desired position 66 in case the bump 54 is present in the powder layer 50, a lateral correction value has to be applied to both laser beams 14a and 14b. As shown in FIG. 3, the laser beam 14a has to be corrected from its position 68a to the left, by a lateral correction value 70. Similarly, the laser beam 14b has to be corrected from its position 68b to the right, by a lateral correction value 72. When the two laser beams are corrected with their respective lateral correction values 70, 72, they impinge on the same desired x-y-position 66, where the uncorrected beams 68a, 68b would impinge in case of an ideally flat powder layer 64.

It should be noted that the lateral correction values may be calculated and provided in the form of a distance (as shown in FIG. 3) or in the form of an angular correction (in degrees) of the irradiation angles 56 and 58, respectively. More precisely, the lateral distances 70, 72 indicated in FIG. 3 refer to lateral distances on the hypothetical flat powder layer 50, i.e., on the work area. From these distances, an angular correction value (in degrees) can be easily calculated (and vice versa) since the distances between the scanning units 30a, 30b and a plane in which the work area extends are known (corresponding to the length of the dashed lines 60 and 62 in FIG. 3).

Further, lateral correction values may not only be calculated and provided for the x-direction but also for the y-direction.

From the example shown in FIG. 3, it is clear that a correction value 70, 72 can be easily calculated by using standard geometry, once the topography of the powder layer 50 is known. The determination of the correction values 70, 72 is carried out by the control unit 40.

A suitable correction value may be determined for each x-y-position of the work area 21. Further, one correction value may be provided for the entire work area 21, although this may not be sufficient for compensating local irregularities in the topography. Further, one or more correction values may only be provided for regions where the topography of the powder layer 50 differs from a plane (i.e., where a bump or dent exists).

The topography of the powder layer 50 is measured by the three-dimensional scanning device 28a, 28b, 29 discussed above and shown, e.g., in FIGS. 1 and 2. In some embodiments it might not be necessary to measure a topography of the entire powder layer (i.e. the powder layer within the entire work area 21). For example, only the topography in an overlap area may be measured and correction values may only be provided for x-y-positions within said overlap area.

It is further noted that, although two laser beams 14a and 14b are shown in FIG. 3, the technique of the present disclosure can also be applied to an apparatus 10 with only one laser beam 14 as shown in FIG. 1. In this case, only the laser beam 14 is calibrated and corresponding correction values are determined. Further, an apparatus may comprise more than two irradiation devices 24 (for example 3, 4, 5, 6, 8, 10, 12, or more), wherein, for each of the irradiation devices 24, corresponding correction values may be determined, in a way similar to that discussed above with regard to FIG. 3.

Further, correction values may not only be determined for the x-y-directions but also for a focus position of the laser beams 14a and 14b. As shown in FIG. 3, at the position of the bump 54, a focal length set in the corresponding irradiation devices 24a, 24b may be reduced to focus the laser spot exactly on a top surface of the bump 54. Similarly, in the case of a dent, the focal length may be increased.

FIG. 4 shows a flowchart of a method for calibration of an irradiation system 24 of an apparatus 10 for additive manufacturing, according to an embodiment of the present disclosure.

The method is carried out by an apparatus for additive manufacturing (such as the apparatus 10 shown and discussed with regard to Figures and 2) during a build process of a three-dimensional workpiece 12.

The method starts with a step of applying 70 a powder layer onto a work area of the apparatus. This step is carried out with the powder application device 18 of the apparatus 10, under the control of the control unit 40.

The method further comprises a step of measuring 72 a topography of at least a section of the powder layer. This step is carried out by the three-dimensional scanning device 28a, 28b, 29 of the apparatus 10, under the control of the control unit 40.

The method further comprises a step of determining 74, based on the measured topography, at least one lateral correction value for an irradiation beam of the irradiation system. This step is carried out by the control unit 40 of the apparatus 10. The method further comprises a step of applying 76 the lateral correction value to scanning data used by the irradiation system for scanning the irradiation beam over the work area. This step is carried out by the control unit 40 of the apparatus 10.

FIG. 5 shows a schematic representation of the control unit 40 of one of the apparatuses 10 of FIG. 1 or FIG. 2. The control unit 40 comprises at least modules 80 and 82, each of which may be represented in the form of hardware and/or software. In one example, the control unit 40 comprises a processor and a memory. On the memory, instructions are stored, which cause the processor to carry out the method shown in FIG. 4. For this purpose, the software stored on the memory may be considered to comprise the modules 80 and 82 shown in FIG. 5.

In detail, these modules are:

Determining module 80 for determining, based on the measured topography, at least one lateral correction value for the irradiation beam of the irradiation system.

Application module 82 for applying the lateral correction value to scanning data used by the irradiation system for scanning the irradiation beam over the work area.

The other elements of the apparatus 10 (i.e., the elements apart from the “logical” elements of the control unit 40) are shown and discussed above with reference to FIGS. 1 and 2.

One or more embodiments of the present technique may have at least one of the following advantages. By carrying out the calibration as described herein, a topography of an applied raw material layer can be considered and compensated. Without the technique described herein, the laser spot might not be directed at the desired position of the workpiece layer. The present technique makes sure that a desired position can be irradiated even in case irregularities exist in the irradiated powder layer.

1-22. (canceled)

23. A method for calibration of an irradiation system of an apparatus for additive manufacturing, the method comprising:
applying a powder layer onto a work area of the apparatus;
measuring a topography of at least a section of the powder layer;
based on the measured topography, determining at least one lateral correction value for an irradiation beam of the irradiation system; and
applying the lateral correction value to scanning data used by the irradiation system for scanning the irradiation beam over the work area.

24. The method of claim 23, further comprising:
irradiating the powder layer with the irradiation beam according to the scanning data to which the lateral correction value has been applied.

25. The method of claim 23, further comprising:
calibrating a lateral position of the irradiation beam with regard to a horizontal plane in the work area.

26. The method of claim 23, wherein the topography is measured via a stripe light projection method.

27. The method of claim 23, further comprising:
determining a predefined lateral position where the irradiation beam shall impinge onto the powder layer,
wherein the lateral correction value is determined such that the irradiation beam impinges onto the powder layer at the predefined lateral position.

28. The method of claim 23, wherein the lateral correction value is determined such that the irradiation beam impinges onto the powder layer at a lateral position corresponding to a lateral position of an intersection point of the irradiation beam without the lateral correction value and a horizontal plane in the work area.

29. The method of claim 23, further comprising:
based on the measured topography, determining at least one further lateral correction value for a further irradiation beam of the irradiation system; and
applying the further lateral correction value to further scanning data used by the irradiation system for scanning the further irradiation beam over the work area.

30. The method of claim 29, wherein the lateral correction value and the further lateral correction value are determined such that the irradiation beam and the further irradiation beam irradiate the same spot on the powder layer when the irradiation beam without the lateral correction value and the further irradiation beam without the further lateral correction value would irradiate the same spot on a horizontal plane in the work area.

31. The method of claim 29, further comprising:
irradiating a first structure into the powder layer using the irradiation beam;
irradiating a second structure into the powder layer using the further irradiation beam;
determining a lateral position of the first structure and a lateral position of the second structure; and
based on the measured topography, the lateral position of the first structure, and the lateral position of the second structure, determining at least one of the at least one lateral correction value and the at least one further correction value.

32. The method of claim 23, wherein the method is carried out for a plurality of consecutive powder layers.

33. The method of claim 23, wherein the at least one lateral correction value is determined based on the measured topography of the applied powder layer and based on a measured topography of a previously applied powder layer.

34. The method of claim 23, further comprising:
based on the measured topography, determining at least one vertical correction value for the irradiation beam of the irradiation system; and
applying the vertical correction value to a focusing optic of the irradiation system.

35. An apparatus for additive manufacturing, the apparatus comprising:
an irradiation system configured to irradiate at least one irradiation beam onto a work area of the apparatus;
a powder application device configured to a powder layer onto the work area of the apparatus;
a topography measurement device configured to measure a topography of at least a section of the powder layer;
a control unit configured to:
based on the measured topography, determine at least one lateral correction value for the irradiation beam of the irradiation system; and
apply the lateral correction value to scanning data used by the irradiation system for scanning the irradiation beam over the work area.

36. The apparatus of claim 35, wherein the control unit is configured to:
calibrate a lateral position of the irradiation beam with regard to a horizontal plane in the work area.

37. The apparatus of claim 35, wherein the topography measurement device is configured to measure the topography via a stripe light projection method.

38. The apparatus of claim 35, wherein the control unit is configured to:
determine a predefined lateral position where the irradiation beam shall impinge onto the powder layer,
wherein the control unit is configured to determine the lateral correction value such that the irradiation beam impinges onto the powder layer at the predefined lateral position.

39. The apparatus of claim 35, wherein the control unit is configured to determine the lateral correction value such that the irradiation beam impinges onto the powder layer at a lateral position corresponding to a lateral position of an intersection point of the irradiation beam without the lateral correction value and a horizontal plane in the work area.

40. The apparatus of claim 35, wherein the control unit is further configured to:
based on the measured topography, determine at least one further lateral correction value for a further irradiation beam of the irradiation system; and
apply the further lateral correction value to further scanning data used by the irradiation system for scanning the further irradiation beam over the work area.

41. The apparatus of claim 40, wherein the control unit is configured to determine the lateral correction value and the further lateral correction value such that the irradiation beam and the further irradiation beam irradiate the same spot on the powder layer when the irradiation beam without the lateral correction value and the further irradiation beam without the further lateral correction value would irradiate the same spot on a horizontal plane in the work area.

42. The apparatus of claim 40, wherein the control unit is further configured to:
control the irradiation system to irradiate a first structure into the powder layer using the irradiation beam;
control the irradiation system to irradiate a second structure into the powder layer using the further irradiation beam;
determine a lateral position of the first structure and a lateral position of the second structure; and
based on the measured topography, the lateral position of the first structure, and the lateral position of the second structure, determine at least one of the at least one lateral correction value and the at least one further correction value.

43. The apparatus of claim 35, wherein the control unit is configured to determine the at least one lateral correction value based on the measured topography of the applied powder layer and based on a measured topography of a previously applied powder layer.

44. The apparatus of claim 35, wherein the control unit is configured to:
based on the measured topography, determine at least one vertical correction value for the irradiation beam of the irradiation system; and
apply the vertical correction value to a focusing optic of the irradiation system.
